(19) United States
(12) Patent Application Publication
(10) Pub. No.: US 2025/0205015 A1
(43) Pub. Date: Jun. 26, 2025

(54) ORTHODONTIC DEVICE

(71) Applicant: Toshiaki USHIGOME, Suginami-ku, Tokyo (JP)

(72) Inventor: Toshiaki USHIGOME, Suginami-ku, Tokyo (JP)

(21) Appl. No.: 18/842,713

(22) PCT Filed: Mar. 1, 2023
(86) PCT No.: PCT/JP2023/007589

§ 371 Date: Aug. 29, 2024

(30) Foreign Application Priority Data
Mar. 1, 2022 (JP) 2022-031147

(51) Int. Cl. A61C 7/08

(52) U.S. Cl. CPC A61C 7/08

(57) ABSTRACT

The subject of this invention is to provide a novel mouthpiece type orthodontic device and orthodontic system that reduces the burden on the patient during orthodontic treatment. A further subject is to provide a mouthpiece type orthodontic device and orthodontic system that enables simultaneous bodily movement of teeth of two or more molars, which has been difficult in the past. A mouthpiece type orthodontic device, comprising a mouthpiece body for fitting to dental arch and an orthodontic force-applying component for applying orthodontic force to the teeth to be straightened, the mouthpiece body has a structure in which at least the teeth to be straightened are exposed without being fitted when the mouthpiece body is fitted to dental arch, the orthodontic force-applying component has a hanging portion for hanging on the teeth to be straightened and a fixing portion fixed to the mouthpiece body, and the orthodontic force-applying component applies an orthodontic force to the teeth to be straightened rooted by the tension between the hanging portion and the fixing portion of the orthodontic force-applying component.

### CROSS-REFERENCE TO RELATED APPLICATIONS

The present application is a National Stage Application of PCT International Application No.: PCT/JP2023/007589 filed on Mar. 1, 2023, which claims priority to Japanese Patent Application 2022-031147, filed with the Japan Patent Office on Mar. 1, 2022, the disclosure of which is incorporated herein by reference in its entirety.

### TECHNICAL FIELD

The present invention relates to orthodontic device, in particular, to a mouthpiece type orthodontic device.

### BACKGROUND ART

Previously, orthodontic devices consisting of metal brackets and wires were usually used for orthodontic treatment.

However, metal brackets and wires are conspicuous, and food debris can easily become lodged between the brackets and teeth, making them unhygienic, so in recent years, mouthpiece type orthodontic devices made of clear plastic have also come into use.

In order to make it easier to move teeth by mouthpiece type orthodontic devices, devices have been devised with additional members that apply an orthodontic force to the teeth to be straightened.

For example, Patent Literature 1 describes an orthodontic system comprising; an orthodontic device comprising a body in which a housing space is formed that can accommodate at least a portion of the user's dental arch and a main protruding portion projecting from the body in a direction away from the housing space, and made of a clear material; and an attachment unit to be bonded to a tooth to be straightened in the dental arch, auxiliary adjusting means having a binding unit attached between the attachment unit and the main protruding portion so as to apply an orthodontic force to the teeth to be straightened.

From the viewpoint of applying orthodontic force, in addition to conventional brackets and wires, orthodontics using orthodontic anchor screws (orthodontic implants) has also been used. In this method, a wire or other means is passed between the anchor screw and the bracket implanted in the patient's gum bone to apply orthodontic force to the teeth, so orthodontic treatment can be performed in a shorter period of time by applying a stronger orthodontic force to the teeth than orthodontic treatment using only brackets and wires, it was also possible to change the position flexibly according to the desired tooth movement direction.

### CITATION LIST

Patent Literature 1: JP 2015-345 A

### SUMMARY OF INVENTION

The system described in the patent literature 1 and the conventionally orthodontic system with bracket and wire have a problem that it is difficult to perform bodily movement of two or more teeth (especially, molars).

In the case of orthodontic implants, the anchor screw is implanted directly into the patient's gums, which can easily cause fear in the patient and is a heavy burden on the patient. In view of the above situation, it is the subject of this invention to provide a novel mouthpiece type orthodontic device and orthodontic system that reduces the burden on the patient during orthodontic treatment. It is a further subject to provide a mouthpiece type orthodontic device and orthodontic system that can make bodily movement of two or more molars at the same time, which has been difficult in the past.

It is a further subject to provide a method for manufacturing a novel mouthpiece type orthodontic device that reduces the burden on the patient during orthodontic treatment.

### Solution to Problem

A present invention, which solves the above subject, is a mouthpiece type orthodontic device, comprising a mouthpiece body for fitting to a dental arch and an orthodontic force-applying component for applying orthodontic force to the teeth to be straightened, wherein the mouthpiece body has a structure in which at least the teeth to be straightened are exposed without being fitted when the mouthpiece body is fitted to the dental arch, the orthodontic force-applying component has a hanging portion for hanging on the teeth to be straightened and a fixing portion fixed to the mouthpiece body and the orthodontic force is applied to the teeth to be straightened using the tension between the hanging portion and the fixing portion in the orthodontic force-applying component as a root.

According to the present invention, it is possible to easily perform bodily movement of teeth (especially two or more molars) while reducing the burden on the patient when performing orthodontic treatment.

The present invention, which solves the above subject, is a mouthpiece type orthodontic device, comprising a mouthpiece body for fitting to the dental arch and an orthodontic force-applying component for applying an orthodontic force to the teeth to be straightened, the mouthpiece body having an open window wherein at least a portion corresponding to the teeth to be straightened is open, the orthodontic force-applying component has a hanging portion for hanging on the teeth to be straightened and a fixing portion fixed to the mouthpiece body, and the orthodontic force is applied to the teeth to be straightened by the tension between the hanging portion and the fixing portion in the orthodontic force-applying component as the root.

The present invention has an open window as “a structure in which at least the teeth to be straightened are exposed without being fitted” as described above. According to the present invention, it is possible to easily perform bodily movement of two or more teeth (especially two or more molars) while reducing the burden on the patient when performing orthodontic treatment.

In a preferred form of the invention, the open window is closed type, with the entire perimeter is defined by a frame.

In another preferred form of the invention, the open window is open type, with a portion of the circumference defined by the frame and spatially open at the portion where the frame is missing.

In a preferred form of the invention, the end of the frame of the open window is raised to form a hook portion, and the orthodontic force-applying component is secured to the mouthpiece body by hanging the fixing portion on the hook portion.

In a preferred form of the present invention, the hanging portion is a member for hanging on the side of the teeth to be straightened in the dental arch direction.

In a preferred form of the invention, the fixing portion is provided on the innermost side of the mouthpiece body in the dental arch direction.

According to the present invention, it is possible to easily perform bodily movement of two or more teeth (especially two or more molars).

In another preferred form of the invention, the hanging portion is a member for hanging on the incisal or occlusal surface of teeth to be straightened.

According to the present invention, orthodontic treatment, especially for the purpose of tooth reduction, can be performed with less burden on the patient.

In a preferred form of the invention, the mouthpiece body is provided with a mating portion for fitting to teeth not to be straightened.

In a preferred form of the invention, the mouthpiece body is provided with a stopper portion for temporarily hanging the hanging portion prior to fitting the mouthpiece body to the dental arch, the stopper portion being connected to the mating portion for mating the teeth not to be straightened adjacent to the teeth to be straightened, the stopper portion is provided with a cutout for temporarily hanging the hanging portion at a position corresponding to the space between the teeth to be straightened and the teeth not to be straightened.

With the hanging part temporarily attached to the stopper portion, the mouthpiece body can be fitted to the dental arch and then the hanging portion can be easily attached to the teeth to be straightened by removing the hanging portion from the stopper portion.

In a preferred form of the invention, the mouthpiece body is provided with a stopper portion for temporarily hanging the hanging portion before fitting the mouthpiece body to the dental arch, the stopper portion being a protruding projection on both sides in the dental arch direction in the mating portion for mating teeth not to be straightened adjacent to the teeth to be straightened.

With the hanging part temporarily attached to the stopper portion, the mouthpiece body can be fitted to the dental arch and then the hanging portion can be easily attached to the teeth to be straightened by removing the hanging portion from the stopper portion.

In a preferred form of the invention, a slit is provided in the mating portion for hanging and securing the fixing portion at a position corresponding to the space between adjacent the teeth not to be straightened, which are mated by the mating portion.

In a preferred form of the invention, at least a connecting portion connecting the hanging portion and the fixing portion in the orthodontic force-applying component is made of a material having resilience.

In a preferred form of the invention, the orthodontic force-applying component is a resilient member that extends from one or two the fixing portions and folds back at the hanging portions to take a circular or semi-circular form.

According to the present invention, it is possible to easily perform bodily movement of teeth (especially two or more molars) while reducing the burden on the patient when performing orthodontic treatment.

In a preferred form of the invention, the thickness of the frame portion in the open window in the mouthpiece body is thicker than the thickness of the other portions.

According to the present invention, the strength of the open window can be increased.

The preferred form of the invention, the mouthpiece body has a contact portion that contacts the hard palate or alveolar ridge.

When an orthodontic force is applied to teeth to be straightened, the reaction force is applied to teeth other than those to be straightened in the opposite direction of the orthodontic force. If the orthodontic force applied to the teeth to be straightened is not so large, the reaction forces on the teeth other than those to be straightened are not so large, and therefore, the movement of teeth other than those to be straightened does not occur. However, if the orthodontic force applied to the teeth to be straightened is large, the reaction forces on the teeth not to be straightened will be large, therefore, there is a risk of unwanted forward movement of teeth not to be straightened to the reaction force. According to the present invention, by providing a contact portion, the mouthpiece body is brought into contact with the hard palate or the alveolar ridge, and even when the orthodontic force applied to the teeth to be straightened is large, the opposing force on the teeth other than those to be straightened can be reduced, thereby preventing unwanted forward movement of the teeth other than those to be straightened.

The present invention to solve the above subject is an orthodontic system, comprising a mouthpiece type orthodontic device as described above, and an orthodontic auxiliary component attached to the teeth to be straightened to prevent the orthodontic force-applying component from detaching from the teeth to be straightened or from biting into the neck of the teeth to be straightened.

If the teeth to be straightened are inclined or if the length of the crown of the teeth is not sufficient to hang the orthodontic force-applying component, the orthodontic force-applying component may detach from the teeth to be straightened and may not provide sufficient orthodontic force. According to the present invention, the orthodontic force-applying component is prevented from detaching from the teeth to be straightened, and sufficient orthodontic force can be applied to the teeth to be straightened to straighten them. In addition, by having the orthodontic auxiliary component to prevent the orthodontic force-applying component from biting into the neck of the teeth to be straightened, the orthodontic force-applying component can be prevented from biting into the neck of the teeth and gums, thereby damaging the gums.

The present invention, which solves the above subject, is a method of manufacturing a mouthpiece type orthodontic device comprising; a correction step wherein a corrected dental model is made, in which the shape of the side of the teeth to be straightened in the patient's dental mold model is corrected so that the gap between the teeth to be straightened is sufficient for the movement of the teeth to be straightened, a molding step wherein a mouthpiece body is made based on a corrected dental model, and a making an open window step wherein an open window is made in the portion of the mouthpiece body corresponding to the teeth to be straightened.

### Advantageous Effects of Invention

According to the mouthpiece type orthodontic device and the orthodontic system of the present invention can reduce the burden on the patient during orthodontic treatment. In addition, the preferred form can facilitate orthodontic treatment for the purpose of bodily movement of two or more molars, which has been difficult in the past.

According to the method of manufacturing a mouthpiece type orthodontic device of the present invention, a novel mouthpiece type orthodontic device can be manufactured, which reduces the burden on the patient during orthodontic treatment.

### BRIEF DESCRIPTION OF DRAWINGS

FIG. 1 shows the first embodiment of the orthodontic device 1 and the patient's dental arch S (upper jaw). The white arrow in the figure represents the attachment of the orthodontic device 1 to the dental arch S.

FIG. 2 (a) shows the attachment of an orthodontic force-applying component 4 between the fixation source 3 of the orthodontic device 1 attached to the dental arch S and the teeth to be straightened T1 or T3. The curved arrows in FIG. 2 (a) represent the attachment of the orthodontic force-applying component 4 to the fixation source 3 and the teeth to be straightened T1 and T3. FIG. 2 (b) shows the orthodontic force-applying component 4 after it is attached between the fixation source 3 and the teeth to be straightened T1 and T3.

FIG. 3 (a) is an enlarged view of a portion of FIG. 2 (a). The white arrow in FIG. 3 (a) represents the attachment of the orthodontic device 1 to the dental arch S. FIG. 3 (b) is an enlarged view of a portion of FIG. 2 (b). The white arrows in FIG. 3 (b) represent the direction of the orthodontic force applied to the teeth to be straightened T3 and T4 and the direction of movement of the teeth to be straightened T3 and T4. H1 and H2 represent the height of the mouthpiece body 2.

FIG. 4 is a view of FIG. 2 (b) from the alveolar ridge side. The white arrows in FIG. 4 represent the direction of the orthodontic force applied to the teeth to be straightened T3 and T4 and the direction of movement of the teeth to be straightened T3 and T4.

FIG. 5 represents a second embodiment of the orthodontic device 1. The white arrows in FIG. 5 represent the direction of the orthodontic force applied to the teeth to be straightened and the direction of movement of the teeth to be straightened.

FIG. 6 shows a vertical cross-sectional view of a dental arch S with a mouthpiece type orthodontic device attached. The leftward arrow in FIG. 6 represents the direction of the reaction force exerted on the teeth other than those to be straightened by applying orthodontic force to the teeth to be straightened. W represents the thickness of the mouthpiece body 2.

FIG. 7 shows the mouthpiece body 2 in the third embodiment.

FIG. 8 shows the orthodontic force-applying component 4 in the third embodiment.

FIG. 9 shows the orthodontic device 1 in the third embodiment which is fitted to the dental arch. The white arrows in the figure represent the direction of the orthodontic force applied to the teeth to be straightened T1 and the direction of movement of the teeth to be straightened T1.

FIG. 10 shows the state of the orthodontic device 1 in the fourth embodiment before fitting it to the dental arch. The hanging portion 41 of the orthodontic force-applying component 4 is temporarily hung on the stopper portion 6.

FIG. 11 shows the fifth embodiment of the orthodontic device 1 before it is attached to the dental arch. The hanging portion 41 of the orthodontic force-applying component 4 is temporarily hung across the two stopper portions 6 and is positioned between the teeth to be straightened and the teeth not to be straightened. (a) represents a side view and (b) represents a plan view.

FIG. 12 shows a plan view of the sixth embodiment of the orthodontic device 1 attached to the dental arch. The white arrows in the figures represent the direction of orthodontic force applied to teeth to be straightened T1 and T2 and the direction of movement of teeth to be straightened T1 and T2.

FIG. 13 shows a part of the orthodontic system of the present invention.

FIG. 14 is a side view of a dental model made before (left in FIG. 14) and after (right in FIG. 14) the use of the mouthpiece type orthodontic device of the present invention.

FIG. 15 is a top view of a dental model made before (left in FIG. 15) and after (right in FIG. 15) the use of the mouthpiece type orthodontic device of the present invention.

### DESCRIPTION OF EMBODIMENTS

Mouthpiece type Orthodontic Device

### First Embodiment

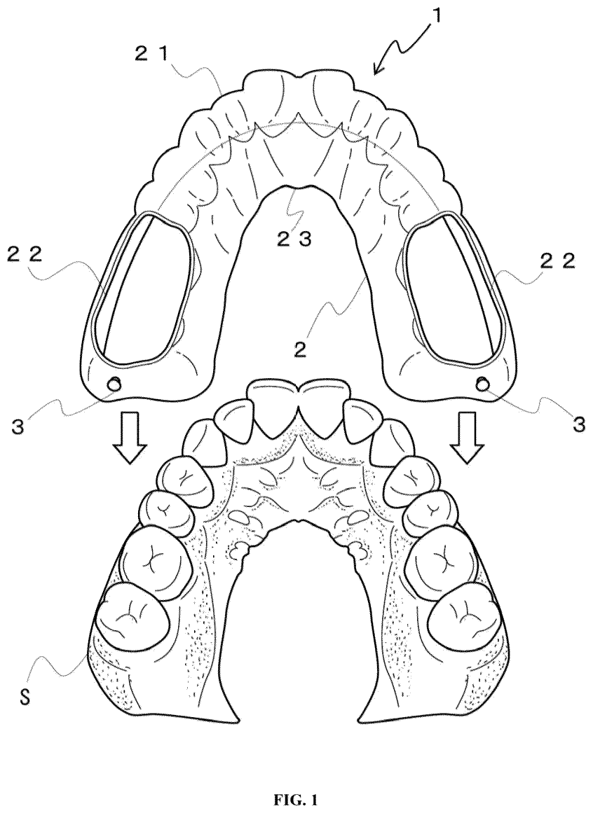

First, the first embodiment of the orthodontic device 1 of the present invention will be described with reference to FIGS. 1 to 4. The orthodontic device 1 shown in FIGS. 1 to 4 is to be worn on the upper side of the dental arch S, however, the configuration is the same when the orthodontic device 1 is worn on the mandibular side of the dental arch.

In this description, the more pharyngeal side of the oral cavity is referred to as the “back side” and the more central incisor side as the “front side”.

FIGS. 1-4 show a first embodiment of an orthodontic device 1. The orthodontic device 1 of the first embodiment comprises a mouthpiece body 2, a fixation source 3, and an orthodontic force-applying component 4. The orthodontic device 1 for the first embodiment is a device for the purpose of orthodontic treatment to move the teeth to be straightened T1 and T2 (left first and second molars) and the teeth to be straightened T3 and T4 (right first and second molars) further back (horizontal movement), respectively.

According to the present invention, the bodily movement of teeth of two or more molars, which was difficult in the past, can be achieved more easily and with less burden to the patient than before. In addition, unlike orthodontic implants, there is no need to provide a fixation source of orthodontic force-applying component 4 directly in the oral cavity, thereby reducing the burden on the patient. Furthermore, the orthodontic device is less conspicuous than conventional orthodontic systems that use wires and brackets, making it aesthetically pleasing and less burdensome to the patient.

In this embodiment, the mouthpiece body 2 has two open windows 22, one open window corresponding to at least the teeth to be straightened T1 and T2 and the other open window corresponding to at least the teeth to be straightened T3 and T4, respectively, a mating portion 21 for mating with teeth not to be straightened (non-straightened teeth), and a contact portion 23 that contacts the hard palate (FIGS. 1-4).

The open window 22 takes the form of a frame defining the entire circumference. In this description, the closed form of the open window 22, in which the entire circumference is defined by the frame, is referred to as a closed type.

In this embodiment, the open window 22 opens in the portion corresponding to teeth to be straightened T1 and T2 as well as T3 and T4, but it may also open including the portion corresponding to teeth not to be straightened, which is anterior to the teeth to be straightened T1 and T3.

In this embodiment, the mating portion 21 is fitted to all of the teeth not to be straightened, but the form of the mating portion 21 is not limited to this, and the mating portion 21 may be fitted to a portion of the teeth not to be straightened.

Furthermore, the mouthpiece body 2 does not have to have the mating portion 21. An example of a form without the mating portion is a form in which the mouthpiece body 2 is formed by a frame covering the gums. In order to fix the positional relationship between the mouthpiece body 2 and the dental arch, the frame and the teeth may be fixed with a spring or the like.

The material of the mouthpiece body 2 is not restricted, and materials normally used in making mouthpiece type orthodontic devices (e.g., polyurethane, thermoplastic resin sheet, acrylic resin for denture base, etc.) can be used as appropriate. From the viewpoint of discreetness of the worn mouthpiece type orthodontic device 1, the material of the mouthpiece body 2 is preferably clear.

The mouthpiece body 2 is manufactured based on the dental arch and bite of the patient who will use the mouthpiece type orthodontic device 1.

For example, the mouthpiece body 2 can be manufactured in the following method. First, the patient's oral cavity and bite are collected using impression material (collection step), and a plaster mold reproducing the patient's dental arch and hard palate or alveolar ridge is made based on this (dental mold model making step). Next, the shape of the portion of the plaster model corresponding to the teeth to be straightened is corrected with a corrective agent such as resin (correction step). Next, a sheet of orthodontic material that has been heated as necessary is pressed onto a corrected plaster model to make it ready for processing, and a mouthpiece is formed (molding step). Finally, the mouthpiece body 2 can be manufactured by opening a window in the cooled mouthpiece as needed in a portion corresponding to the open window 22 (making an open window step). The mouthpiece type orthodontic device 1 is also subjected to a removal step to remove the excess portion of the mouthpiece, leaving the contact portion 23, which will be described later.

As described below, the open window 22 is provided with a gap to the teeth to be straightened that is sufficient for orthodontic movement. Therefore, the correction in the above correction step can be performed by applying and as necessary drying, curing, and polymerizing etc. the correction agent described below to the side of the part corresponding to the teeth to be straightened in the mouthpiece body 2 that has undergone the above making the open window step so that a gap sufficient for movement of the teeth to be straightened can be secured between the open window 22 and the teeth to be straightened.

This can provide a sufficient gap for the teeth to be straightened to be moved, as well as to prevent the orthodontic force-applying component 4 from contacting or biting into the root of the patient's teeth, and to set the fixing portion 43 (or the fixation source 3), as described below, at an appropriate position.

The corrective agent is not limited to the resin described above, but can be applied to the side of the part of the patient's dental model corresponding to the teeth to be straightened, and then dried (any drying method), cured (any curing method), polymerized (any polymerization method), etc. as necessary to form the shape of the open window 22 as described below, plaster or other known materials can be employed as appropriate.

The manufacturing of the mouthpiece body 2 can also be performed in whole or in part on a computer.

Specifically, the collection step can be performed using optical impressions. In this case, the dental mold model making step can be performed by outputting the data collected by the optical impression using a 3D printer. In this case, the correction and subsequent steps can be performed in the same manner as described above. The subsequent steps can also be performed on a computer.

Next, the correction step can also be performed on a computer. In this case, the data reproducing the patient's dental arch, hard palate, or alveolar ridge taken by optical impression (hereinafter referred to as “dental mold data”) is corrected by editing the lateral data of the portion corresponding to the teeth to be straightened in the dental mold data to ensure sufficient gaps for the movement of the teeth to be straightened, thereby obtaining the corrected dental mold data. The shape correction on the data can be performed on a computer using known tools such as CAD.

At this time, the molding step can be performed by creating mouthpiece data based on the corrected dental mold data and outputting the created mouthpiece data using a 3D printer. The subsequent steps can also be performed on a computer.

Furthermore, the mouthpiece body 2 can also be produced by producing mouthpiece data based on the corrected dental model data, editing the produced mouthpiece data to have the open window (open window mouthpiece data production step), and then outputting the produced mouthpiece data by a 3D printer (output step). In this case, the mouthpiece type orthodontic device 1 can be easily manufactured because the entire process from the correction step to the open window mouthpiece data production step can be performed by a computer.

In the case of integrally forming the fixation source 3 described below with the mouthpiece body 2, for example, the parts corresponding to the fixation source 3 can be glued together in the above correction step, and the mouthpiece can be formed based on this. When the mouthpiece body 2 is made by computer, the dental mold data can be edited to have parts corresponding to the fixation source 3, which can then be used in subsequent steps to form the mouthpiece and the fixation source 3 in one piece.

Any of the steps are not limited to the above-described form, and any of the known methods can be adopted as appropriate.

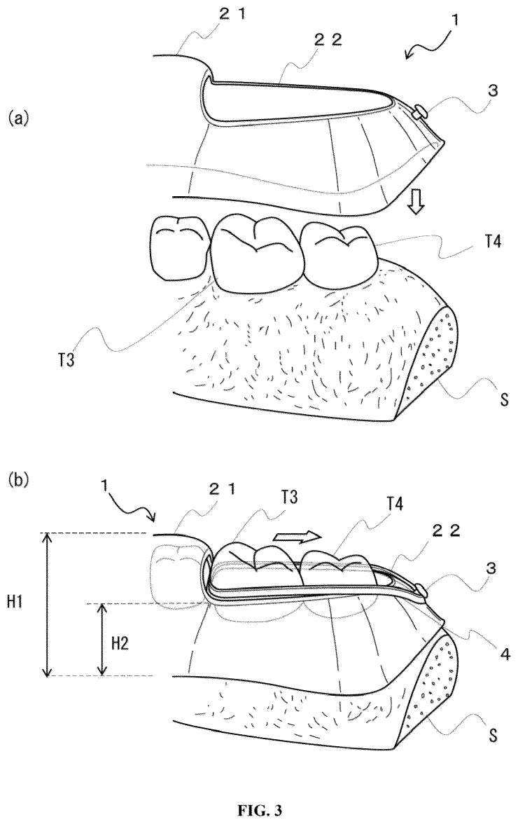

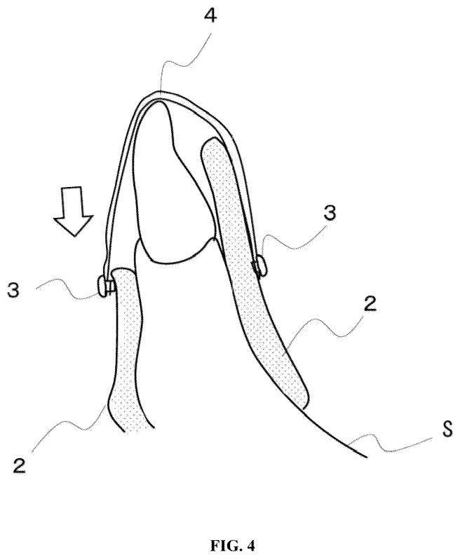

The open window 22 is provided for teeth to be straightened T1 and T2, as well as T3 and T4, with a gap sufficient for the bodily movement of teeth (especially FIG. 3 (b) and FIG. 4).

In this embodiment, the width (length perpendicular to the dental arch) of the open window 22 is constant, but it is preferable to become wider toward the fixation source.

The position of the open window 22 is not limited to the position represented in FIGS. 1 through 4, but can be located at an appropriate position on the mouthpiece body 2 according to the position of the teeth to be straightened.

For example, if the teeth to be straightened are canines, the open window 22 can be provided in the portion of the mouthpiece body 2 corresponding to the canines, leaving a gap sufficient for the movement of the canines. The same applies to teeth in other positions.

The size of the open window 22 can be set appropriately, taking into consideration the number of teeth to be straightened and the strength of the mouthpiece type orthodontic device 1, so that the gap necessary to straighten the teeth to be straightened can be secured. The size of the gap required for the movement of the teeth to be straightened can be set according to the size of the teeth to be straightened, the desired movement distance, the desired movement direction, and the purpose of orthodontic treatment.

Preferably, the open window 22 is provided so that at least the crown of the teeth, excluding the neck, is exposed. Even more preferably, the open window 22 is provided so that the gums of the teeth to be straightened are not exposed.

The open window 22 in the above form prevents the orthodontic force-applying component 4 from cutting into the patient's gums.

In this embodiment, the open window 22 is symmetrical, but the open window 22 can be asymmetrical depending on the position of the teeth to be straightened. For example, if only teeth to be straightened T3 and T4 in FIGS. 1-4 need to be bodily movement of teeth and T1 and T2 do not need to be moved, only the open window 22 that exposes teeth to be straightened T3 and T4 can be provided.

In this embodiment, the open window 22 is provided so that the occlusal surfaces of the teeth to be straightened T1-T4 are exposed, but the direction of the open window can be changed according to the purpose of orthodontic treatment. For example, the open window 22 can be provided so that the side surface of the teeth to be straightened (either the outer or inner side of the mouth) is exposed.

The mouthpiece body 2 may have the same thickness as a whole, but preferably the thickness of the frame portion of the open window 22 is thicker than the rest of the mouthpiece body.

According to the present invention, the strength in the open window 22 of the mouthpiece type orthodontic device 1 can be increased.

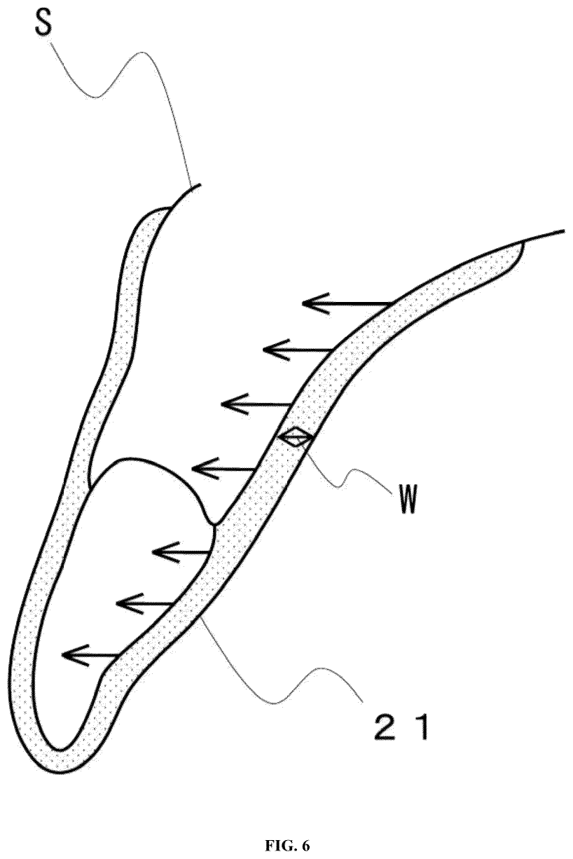

In the present invention, “thickness” refers to the length of the mouthpiece type orthodontic device 1 perpendicular to the gums (W in FIG. 6), and “height” refers to the length of the portion parallel to the teeth and gums (H1 and H2 in FIG. 3 (b)).

The thickness of the mouthpiece body 2 can be set according to the material that makes up the mouthpiece body 2. For example, when the mouthpiece body 2 is made of a material with relatively high flexibility, such as thermoplastic resin sheet, the thickness of the mouthpiece body 2 can be 0.4 to 8.0 mm to prevent the mouthpiece type orthodontic device 1 from bending or distorting when the orthodontic force-applying component 4 is attached to the mouthpiece body.

When the mouthpiece body 2 is made of a material with relatively low flexibility, such as dental metal, carbon resin, or zirconia, for example, the thickness of the mouthpiece body 2 can be 0.4 to 8.0 mm, as in the case of a material with relatively high flexibility, or the thickness of the mouthpiece body 2 can be extremely thin, 0.5 mm or less.

The height H1 and H2 of the mouthpiece body 2 can be set according to the purpose of orthodontic treatment and the position of teeth to be straightened.

Preferably, the thickness of the frame portion of the open window 22 is at least 1.1 times thicker than the thickness of the other portions, and at least 3 times thicker.

According to the present invention, the strength in the open window 22 of the mouthpiece type orthodontic device 1 can be increased.

The upper limit of the thickness of the frame portion of the open window 22 can be determined by a combination of the strength of the mouthpiece type orthodontic device and the patient's comfort, but it can be, for example, about 3 times as thick.

The thickness of the frame portion of the open window 22 can be adjusted, for example, by overlapping and bonding a sheet of the same material as the mouthpiece body 2 to the frame portion of the open window 22, but the thickness adjustment method is not limited to this.

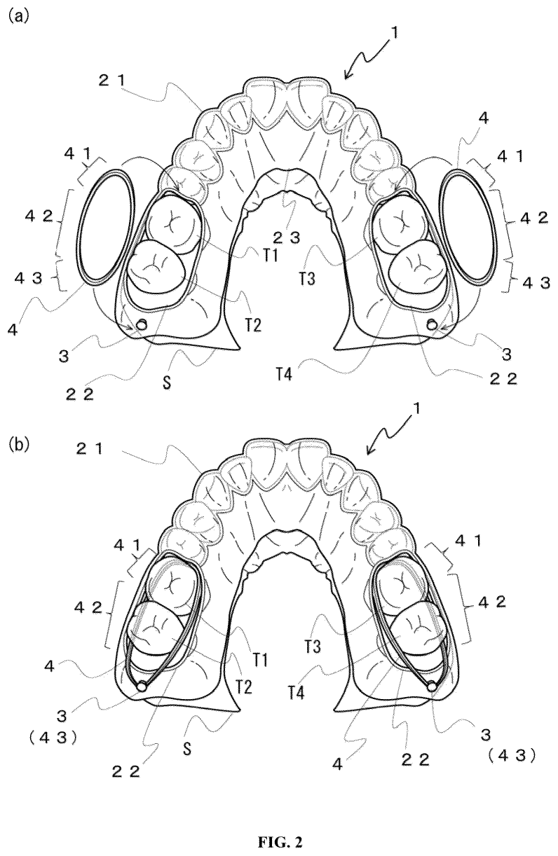

In this embodiment, the orthodontic force-applying component 4 is an orthodontic elastics (ring-shaped rubber) (FIGS. 2-4). In other words, in this embodiment, the orthodontic force-applying component 4 consists of a resilient material that extends from one fixing portion 43 and folds back at the hanging portion 41 to take a circular form.

According to the present invention, orthodontic force can be applied to teeth to be straightened easily and efficiently.

However, if the orthodontic force-applying component 4 has a hanging portion 41 for hanging on the teeth to be straightened and a fixing portion 43 fixed to the mouthpiece body 2, and the tension between the hanging portion 41 and the fixing portion 43 is used as the root to apply orthodontic force to teeth T1-T4 (FIG. 3 (b) white arrow, FIG. 4 white arrow), the specific components are not limited to orthodontic elastics.

The orthodontic force-applying component 4 does not necessarily have to have a connecting portion 42 (i.e., the hanging portion 41 and the fixing portion 43 may be directly connected) if tension can be generated between the hanging portion 31 and the fixing portion 43, but it is preferable to have a connecting portion 42 made of a material having resilience.

In this embodiment, the fixing portion 43 is composed of a button-shaped fixation source 3 on the innermost side of the mouthpiece body 2 in the dental arch direction (further from the innermost tooth). In other words, in this embodiment, the fixing portion 43 is provided in a straight line anteriorly in the direction of the desired movement of the teeth to be straightened (in the back of the mouth).

According to the present invention, the bodily movement of teeth of two or more molars, which was difficult in the past, can be achieved more easily and with less burden to the patient than before. In addition, not as with orthodontic implants, there is no need to provide a fixation source of orthodontic force-applying component 4 directly in the oral cavity, thereby reducing the burden on the patient. Furthermore, the orthodontic device is less conspicuous than conventional orthodontic systems that use wires and brackets, making it aesthetically pleasing and less burdensome to the patient.

However, the method of fixing the fixing portion 43 to the mouthpiece body 2 is not limited to this, as long as the orthodontic force-applying component 4 can be fixed to the mouthpiece body 2. For example, the fixing portion 43 can be attached to a hook-shaped fixation source 3 (a separate material from the mouthpiece body 2 can be bonded or integrally molded with the mouthpiece body 2), or the fixing portion 43 and the mouthpiece body 2 can be directly bonded.

However, as described below, when the orthodontic force-applying component 4 (or at least the connecting portion 42) is to be replaced periodically to maintain its ability to apply orthodontic force, it is preferable to fix the orthodontic force-applying component 4 to the mouthpiece body 2 by fixing the fixing portion 43 to the fixation source 3.

In the present invention, “fixing the orthodontic force-applying component 4 to the mouthpiece body 2” means that the orthodontic force-applying component 4 does not detach from the mouthpiece body 2 (or fixation source 3) while the patient is using the mouthpiece type orthodontic device 1 according to the present invention. In other words, the orthodontic force-applying component 4 may be fixed to the mouthpiece body 2 (or fixation source 3) or detached from the fixation source 3 when the patient is not using the mouthpiece type orthodontic device 1 of the present invention. Therefore, the orthodontic force-applying component 4 may detach from the mouthpiece body 2 or fixation source 3 when the orthodontic force-applying component 4 is replaced as necessary during maintenance of the mouthpiece type orthodontic device 1.

The position of the fixing portion 43 on the mouthpiece body 2 is not limited to the position shown in FIGS. 1 to 4, but should be located in front of the teeth to be straightened in the desired direction of movement (including both straight ahead and diagonally ahead).

For example, in the case of orthodontic treatment for the purpose of bodily movement (horizontal movement) of canine only to the back of cavity, the desired movement can be achieved by fixing the orthodontic force-applying component 4 to the mouthpiece body 2 directly or via the fixing portion 43 at a position corresponding to the teeth further back than the canine teeth. The same is true for teeth in other positions and for orthodontic purposes.

The orthodontic force-applying component 4 can preferably be replaced periodically, at least for the connecting portion 42, in order to maintain its orthodontic force-applying capacity. For example, when the orthodontic elastics is used as the orthodontic force-applying component 4, it is preferably replaced once a day. The frequency of replacement can be set according to the material of the connecting portion 42.

In this embodiment, as described above, the orthodontic force-applying component 4 is a ring-shaped orthodontic elastics (i.e., a member having resilience that extends from one fixing portion 43 and folds back at the hanging portion 41 to take a ring-shaped form), but the form of the orthodontic force-applying component 4 is not limited to this.

To achieve the effect of the present invention, it is sufficient to create tension between the hanging portion 31 and the fixing portion 43, as described above. When the orthodontic force-applying component 4 has the connecting portion 42, at least the connecting portion 42 need only be a component made of a material having resilience, and the hanging portion 41 and the fixing portion 43 may be components made of different materials (including materials having no resilience). For example, the hanging portion 41 may be made of any material or shape that can be used in the oral cavity, such as a hook or a plate having a curved surface, and can be attached to teeth to be straightened. The material, shape, and size of the fixing portion 43 are not particularly restricted as long as the fixing portion 43 can fix the orthodontic force-applying component 4 to the mouthpiece body 2 and it is made of a material that can be used in the oral cavity.

In this embodiment, the fixing portion 43 is fixed by the fixation source 3 at the innermost side of the mouthpiece body 2 in the direction of the dental arch (FIGS. 1-4).

According to the present invention, the bodily movement of teeth of two or more molars, which was difficult in the past, can be achieved more easily and with less burden to the patient than before.

However, as mentioned above, it is not essential to provide a fixation source 3, and the fixing portion 43 of the orthodontic force-applying component 4 can be directly bonded to the mouthpiece body 2, and the same effect is achieved in this case. When the fixation source 3 is provided, its position is not limited to the positions shown in FIGS. 1 to 4, but can be set appropriately so that it is located in front of the teeth to be straightened in the direction of movement according to the position of the teeth to be straightened in the dental arch and the purpose of orthodontic treatment.

Furthermore, when providing the fixation source 3, its material and shape are not limited as long as the orthodontic force-applying component 4 can be fixed to the fixation source 3, for example, a different material with a different shape can be bonded to the mouthpiece body 2, or it can be integrally molded with the mouthpiece body 2.

In this embodiment, the mouthpiece body 2 has a contact portion 23 on the part of the mouthpiece body 2 that contacts the hard palate (FIGS. 1 and 2). However, when the orthodontic device 1 is worn on the mandibular side of the dental arch, the contact portion 23 is in contact with the alveolar ridge.

Preferably, at least in use, the contact portion 23 is provided with a contact layer (not shown) to stabilize the contact state between the mouthpiece body 2 and the hard palate or the alveolar ridge.

In orthodontic treatment using the mouthpiece type orthodontic device 1, a force toward the front side acts on the teeth other than the teeth to be straightened as a reaction to the orthodontic force applied to the teeth to be straightened (leftward arrow in FIG. 6). If the orthodontic force applied to the teeth to be straightened is not so large, the opposing force applied to the teeth other than those to be straightened is also not so large, and therefore, no or very little movement of the teeth other than those to be straightened occurs, which is not a problem in orthodontic practice.

However, when the orthodontic force applied to the teeth to be straightened is large, the opposing force on the teeth other than those to be straightened also is large, which may cause unwanted forward movement of the teeth other than those to be straightened that are subjected to the opposing force. According to the present invention, however, the contact portion brings the mouthpiece body into contact with the hard palate or the alveolar ridge, thereby reducing the opposing forces on teeth other than those to be straightened, even when the orthodontic force applied to the teeth to be straightened is large. The contact layer, at least when in use, can further stabilize the state of contact between the mouthpiece body 2 and the hard palate or alveolar ridge, thereby reducing the opposing forces applied to teeth other than those to be straightened.

The size of the contact portions can be adjusted as necessary when the mouthpiece body 2 is made.

The contact layer is not limited to any particular material as long as it can stabilize the contact between the mouthpiece body 2 and the hard palate or alveolar ridge.

For example, a known denture stabilizer can be applied to the contact portion 23 of the mouthpiece body 2 and bonded to the hard palate or alveolar ridge. In this case, the adhesive layer between the contact portion 23 and the hard palate or alveolar ridge is the contact layer referred to herein. In other words, the contact layer referred to herein can be molded in time.

In addition, the present invention is not limited to the time-formed form as described above, and the contact layer may be provided even when not in use.

The mouthpiece type orthodontic device 1 or the present invention can be used in the same manner as known mouthpiece type orthodontic devices.

Although it can be worn for at least 20 hours per day, it is preferable to continue wearing the device throughout the day, except for meal and tooth brushing time.

The period of use (from the start of orthodontic treatment to the end of orthodontic treatment) can be set according to the condition of the patient's teeth and dental arch before orthodontic treatment and the purpose of orthodontic treatment.

### Second Embodiment

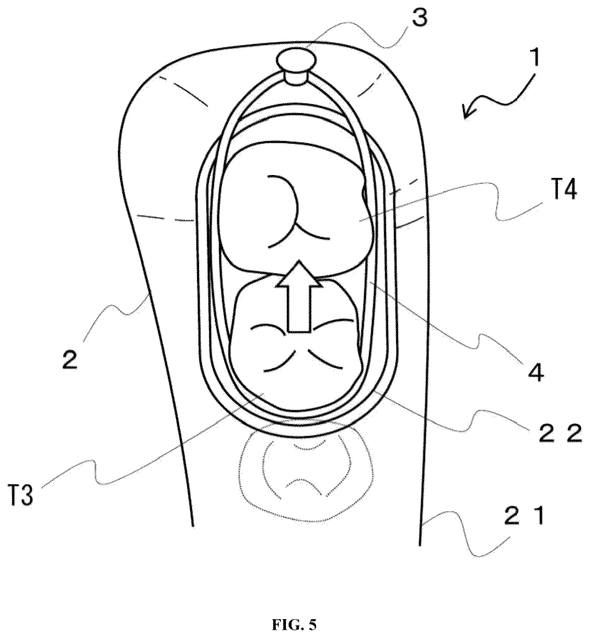

Referring to FIG. 5, the second embodiment of the mouthpiece type orthodontic device 1 of the present invention is described. The parts in common with the first embodiment are omitted.

The second type of orthodontic device is an orthodontic device used for orthodontic treatment aimed at depressing teeth to be straightened.

In this embodiment, the mouthpiece body 2 of the mouthpiece type orthodontic device 1 is provided with two fixing portions 43 so that they are located on opposite sides of each other across the teeth to be straightened in the frame portion of the open window 22. In other words, the two fixing portions 43 are provided in front of the teeth to be straightened in the direction of movement (depression). The two fixing portions 43 are composed by hanging fixing portions 43 on two fixation sources 3 provided on the frame portion of the open window 22 of the mouthpiece body 2 so that they are located on opposite sides of each other across the teeth to be straightened.

In this embodiment, the orthodontic force-applying component 4 is an orthodontic elastics, which is fixed to the mouthpiece body 2 at two fixing portions 43 and takes an abbreviated U-shape. In other words, the orthodontic force-applying component in this embodiment is a resilience member that extends from the two fixing portions 43 and folds back at the hanging portions 41 to take a semi-circular form.

However, the positional relationship and other forms of the fixing portion 43 (fixation source 3) are not limited to the form represented in FIG. 5. The hanging portion 41 may hang on the occlusal surface depending on the teeth to be straightened.

The mouthpiece type orthodontic device 1 of the second embodiment can be manufactured in the same manner as the first embodiment.

### Third Embodiment

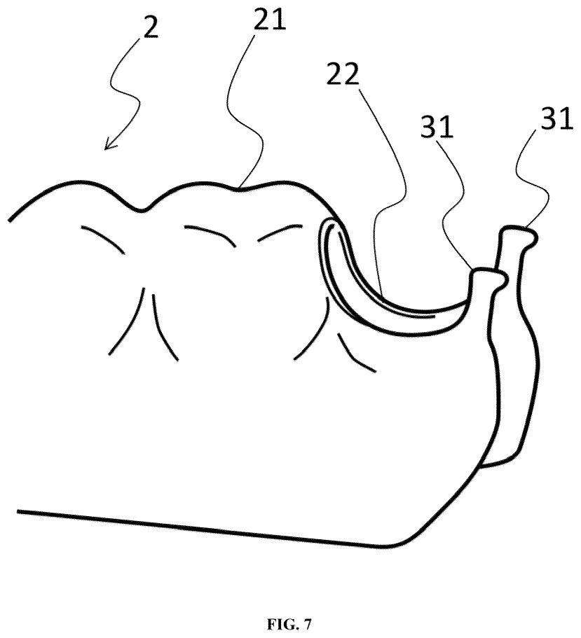

Referring to FIGS. 7-9, a third embodiment of the mouthpiece type orthodontic device 1 of the present invention is described. The parts in common with the first and second embodiments are omitted.

The mouthpiece body 2 of the third embodiment of the mouthpiece type orthodontic device 1 is shown in FIG. 7. The mouthpiece body 2 has an open window 22 with a portion of the circumference defined by a frame on the side of the teeth to be straightened T1. The open window 22 is spatially open because the frame of the open window 22 is missing at the rear portion of the teeth to be straightened T1. In this description, the open window 22 in the form shown in FIG. 7, where a portion of the circumference is defined by the frame and is spatially open at the portion where the frame is missing, is referred to as an open type open window.

The third embodiment with an open type open window 21 does not require a frame to be placed further back from the molars as in the first embodiment, thus reducing the pressure in the mouth when worn. Furthermore, strong orthodontic force can be exerted even in cases where a frame cannot be placed further back due to space issues.

In the third embodiment, the ends of both frames of the open window 22 are raised to form two hook portions 31 (corresponding to fixation source 3). The two hook portions 31 are provided on the buccal and palatal sides opposite each other across the teeth to be straightened T1 (FIG. 7).

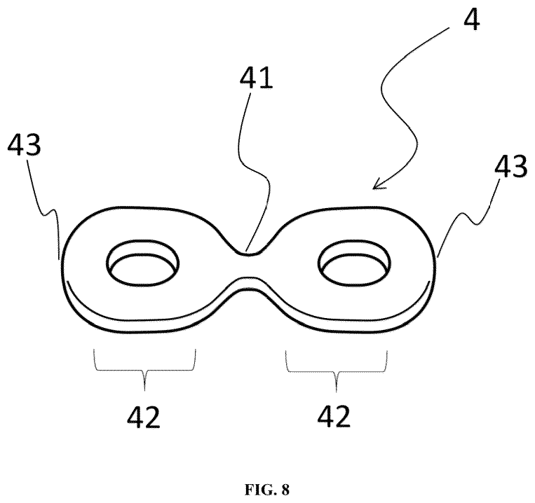

The orthodontic force-applying component 4 of the third embodiment has a figure-8 structure with two circular structures connected (FIG. 8). The orthodontic force-applying component 4 is fixed to the mouthpiece body 2 by hanging portions of the circular structures at both ends on hook portions 31 (FIG. 9). Then, by attaching the portion connecting the circular structure to the teeth to be straightened, an orthodontic force is applied to the teeth to be straightened (FIG. 9). In other words, the end of the circular structure in the orthodontic force-applying component 4 functions as the fixing portion 43, the portion connecting the two circular structures functions as the hanging portion 41, and the space between the fixing portion 43 and the hanging portion 41 functions as the connecting portion 42.

The orthodontic force-applying component 4 of the third embodiment has a figure-8 structure, but its form can be designed and modified as long as it can be fixed to the hook portion 31 and can be hung on the teeth to be straightened T1.

### Fourth Embodiment

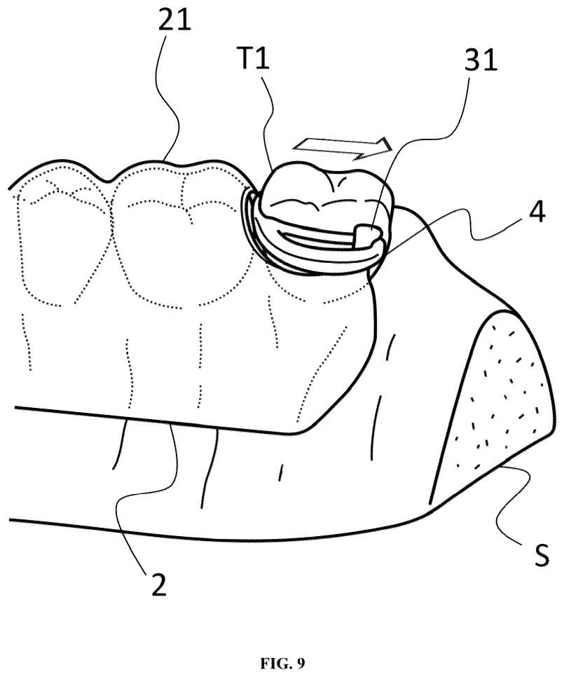

The fourth embodiment is explained with reference to FIG. 10. Parts in common with the first through third embodiments are omitted.

The structure of the mouthpiece body 2 of the fourth embodiment is generally the same as that of the third embodiment, but differs in that it has a stopper portion 6 (FIG. 10). The stopper portion 6 is used to temporarily hang the hanging portion 41 of the orthodontic force-applying component 4 before fitting the mouthpiece body 2 into the dental arch.

The stopper portion 6 is connected to a mating portion 21 for mating teeth not to be straightened adjacent to the teeth to be straightened T1. Specifically, it protrudes from the mating portion 21 in the direction of the open window portion 22. The stopper portion 6 is shaped to conform to a portion of the upper surface of the teeth to be straightened T1 so as not to interfere with the teeth to be straightened T1 exposed through the open window 22 when the mouthpiece body 2 is fitted to the dental arch (FIG. 10).

The stopper portion 6 is equipped with a cutout 61 for temporarily hanging portion 41 at a position corresponding to the space between teeth to be straightened T1 and teeth not to be straightened (FIG. 10).

Before fitting the mouthpiece body 2 into the dental arch, the fixing portion 43 of the orthodontic force-applying component 4 is hung on the hook portion 31 and the hanging portion 41 is temporarily hung in the cutout 61 of the stopper portion 6 (FIG. 10).

The orthodontic device 1 set in the state illustrated in FIG. 10 can be fitted to the dental arch, and the hanging portion 41 of the orthodontic force-applying component 4 that has been temporarily hung on the stopper portion 6 can be removed to easily hang the hanging portion 41 on the teeth to be straightened T1.

### Fifth Embodiment

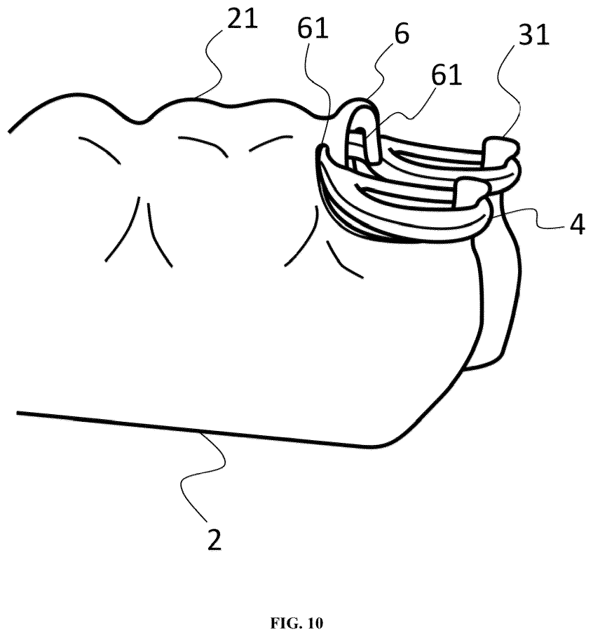

The fifth embodiment is described with reference to FIG. 11. Parts in common with the first through fourth embodiments are omitted.

The structure of the mouthpiece body 2 of the fifth embodiment is generally the same as that of the third embodiment, but differs in that it has a stopper portion 6 for temporarily hanging portion 41 before fitting mouthpiece body 2 into the dental arch (FIG. 11).

The stopper portion 6 is provided in the mating portion 21 for mating the teeth not to be straightened adjacent to the teeth to be straightened T1. Specifically, the stopper portion 6 is a protrusion provided on both sides (buccal and palatal sides) of the mating portion 21 in the dental arch direction (FIG. 11).

Before fitting the mouthpiece body 2 into the dental arch, the fixing portion 43 of the orthodontic force-applying component 4 is hung on the hook portion 31, and the hanging portion 41 is temporarily hung on the two stopper portions 6 as illustrated in FIG. 11. In the temporary hanging state, the hanging portion 41 of the orthodontic force-applying component 4 is stretched over the two stopper portions 6 and is positioned in the area corresponding to the space between the teeth to be straightened T1 and teeth not to be straightened.

The orthodontic device 1 set in the state illustrated in FIG. 11 can be fitted to the dental arch, and the hanging portion 41 of the orthodontic force-applying component 4, which was temporarily hung on the stopper portion 6, can be removed to easily hang the hanging portion 41 on the teeth to be straightened T1.

### The Sixth Embodiment

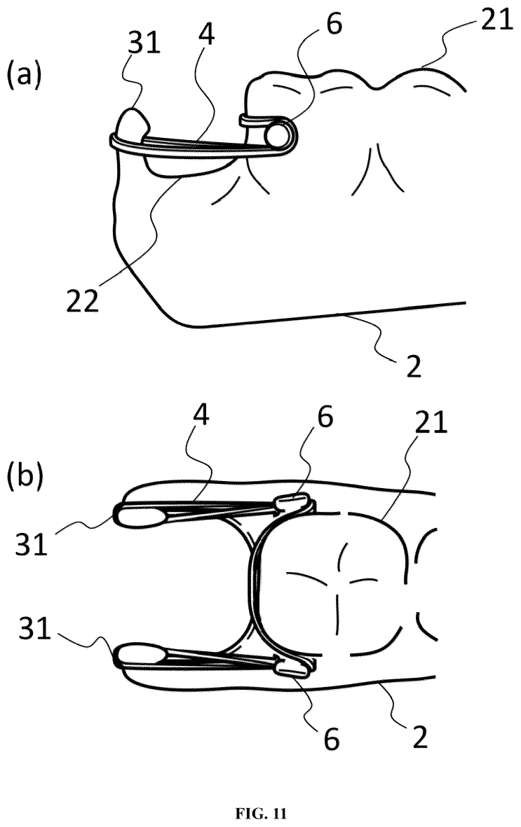

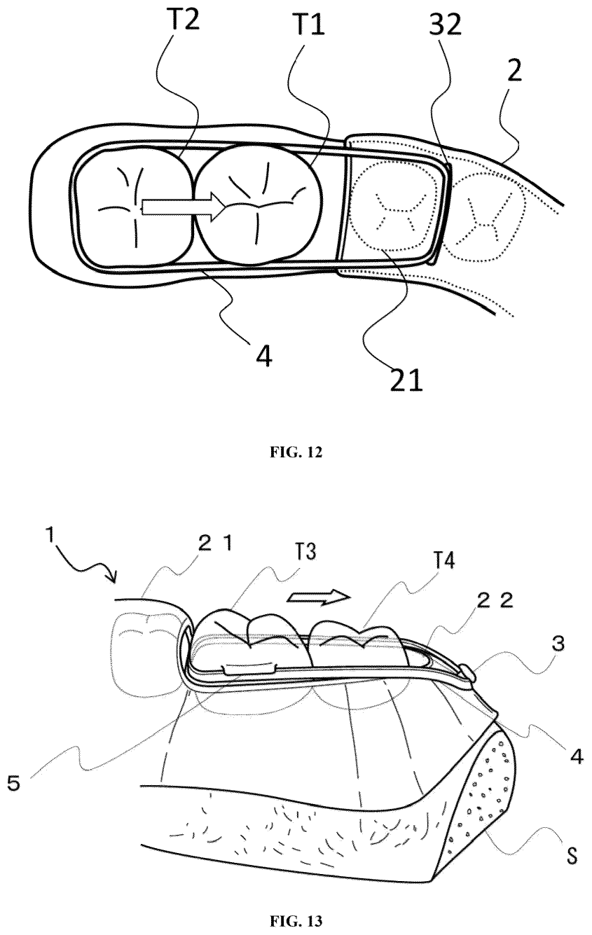

The sixth embodiment is described with reference to FIG. 12. Parts in common with the first through fifth embodiments are omitted.

The mouthpiece body 2 of the sixth embodiment has a structure in which the teeth to be straightened, T1 and T2, are exposed without being mated when fitted into the dental arch. And, unlike the first through sixth embodiments, it is not equipped with a member that corresponds to the “frame” of the open window (FIG. 12).

The characteristic part of the sixth embodiment is that the mating portion 21 is provided with a slit 32 (corresponding to the fixation source 3). The slit 32 is provided at a position corresponding to the space between adjacent teeth not to be straightened which are mated by the mating portion 21 (FIG. 12).

When the orthodontic device 1 is fitted into the dental arch, the fixing portion 43 of the orthodontic force-applying component 4 is fixed to the mouthpiece body 2 by hanging on the slit 32. The fixing portion 43 is positioned between the teeth not to be straightened. On the other hand, the hanging portion 41 of the orthodontic force-applying component 4 fixed in the slit 32 is hung on the teeth to be straightened T2 (FIG. 12).

By wearing the orthodontic device 1 of the sixth embodiment as illustrated in FIG. 12, an orthodontic force is applied to the teeth to be straightened T1 and T2, rooted in the tension between the fixing portion 43 and the hanging portion 41 fixed to the slit 32.

In the sixth embodiment, the orthodontic force-applying component 4 is configured so that the tension of the orthodontic force-applying component 4 is not applied to teeth not to be straightened, but is applied entirely to the slit 32. This prevents unintended movement of teeth not to be straightened.

### Orthodontic System

FIG. 13 shows part of the orthodontic system for the present invention. The orthodontic system for the present invention is equipped with the mouthpiece type orthodontic device 1 described above and an orthodontic auxiliary component 5 that is attached to the teeth to be straightened and prevents the orthodontic force-applying component 4 that is attached to the teeth to be straightened from detaching from the teeth to be straightened.

If the teeth to be straightened are inclined or if the length of the crown of the teeth is not long enough to hang the hanging portions 41 of the orthodontic force-applying component 4, the hanging portions 41 of the orthodontic force-applying component 4 may detach from the teeth to be straightened and may not provide sufficient orthodontic force.

According to the present invention, the orthodontic force-applying component 4 can be prevented from detaching from the teeth to be straightened. As a result, even if the teeth to be straightened are inclined or the length of the teeth crown is not long enough to hang the orthodontic force-applying component 4, the orthodontic force can be applied to the straightened teeth and the teeth can be straightened according to the purpose.

In this embodiment, the orthodontic auxiliary component 5 is provided to prevent the orthodontic force-applying component 4 from detaching from the teeth to be straightened, but it may also be provided to prevent the orthodontic force-applying component 4 from cutting into the cervical portion of the teeth to be straightened.

In this case, the orthodontic auxiliary component 5 is provided on the lateral side of the tooth neck from the orthodontic force-applying component 4.

Orthodontic auxiliary component 5 can be made of any material used in dentistry. For example, a clay-like photo-curing resin can be applied to the sides of teeth to be straightened (either on the palatal or lingual side, or on the buccal or labial side), and the resin is polymerized by exposure to light.

### Manufacturing Method of Mouthpiece Type Orthodontic Device

A method of manufacturing a mouthpiece type orthodontic device comprising;
a correction step wherein a corrected dental model is made, in which the shape of the side of the teeth to be straightened in the patient's dental mold model is corrected so that the gap between the teeth to be straightened is sufficient for the movement of the teeth to be straightened,
a molding step wherein a mouthpiece body is made based on a corrected dental model, and
a making an open window step wherein an open window is made in the portion of the mouthpiece body corresponding to the teeth to be straightened.

According to the present invention, it is possible to produce a mouthpiece type orthodontic device that can reduce the burden on the patient during orthodontic treatment. It is also possible to produce a mouthpiece type orthodontic device that can facilitate orthodontic treatment for the purpose of bodily movement of teeth of two or more molars, which has been difficult in the past.

However, the manufacturing method of the mouthpiece type orthodontic device may include other necessary steps as appropriate. For example, the method may include, as appropriate, a collection step in which the oral cavity and bite of the patient are collected using impression material; a dental mold model making step in which a plaster cast model of the patient's dental arch, hard palate or alveolar ridge is made based on the oral cavity and bite of the patient collected in the collection step; a mouthpiece forming step in which the mouthpiece is formed based on the corrected plaster cast model; and/or a removal step in which excess portions of the mouthpiece are removed. In the removal step, the excess portion of the mouthpiece can be removed so as to leave the contact portion 23.

In addition, all steps can be made digitally using optical impressions and design software 3D printers. Specifically, optical impressions are used to obtain the patient's 3D tooth mold data, and based on this data, a 3D data for a mouthpiece that matches the patient's dental mold model is made by a computer. The 3D data of the mouthpiece is edited on the computer to create a shape with a gap sufficient for the movement of the teeth to be straightened and an open window in the area corresponding to the teeth to be straightened. The 3D data of the mouthpiece thus obtained can be output by a 3D printer to manufacture the orthodontic device.

### Scope of Application

The first, third through fifth forms of orthodontic devices described above are mainly intended for the purpose of bodily movement of teeth. The second form of orthodontic device is an embodiment aimed at depressions. However, the application of the invention is not limited to the specifically illustrated and described bodily movement of teeth and depressions.

The present invention can be applied to inclined and erupted teeth by adjusting the position of the fixation source that fixes the fixing portion of the orthodontic force-applying component and the positional relationship of the teeth on which the hanging portion is hung as appropriate. Specifically, the orthodontic device can also be used for the orthodontic application of embedded teeth, ectopic erupted teeth, inclined teeth, twisted teeth, and C3 treated teeth.

### EXAMPLES

The invention will be described in more detail below with reference to examples, but the technical scope of the invention is not limited to the following examples.

### Example

A mouthpiece type orthodontic device 1 shown in FIG. 2 was manufactured. The teeth to be straightened were the left and right first molars and second molars, four in total. The mouthpiece body 2 for this example was made by the following method.

### <Method of Making the Mouthpiece Body 2>

(1) The oral cavity of the inventor was collected by a general method using impression material (collection step), and a plaster cast model was made (dental mold model making step).
(2) In order to secure a gap in the mouthpiece body sufficient for the movement of the teeth to be straightened and to prevent the orthodontic force-applying component from cutting into the root of the teeth to be straightened, resin was applied as a correction agent to the position corresponding to the side of the portion corresponding to the teeth to be straightened, polymerized, and the shape of the plaster model made in step (1) above was corrected (correction step). The corrected plaster model and commonly used thermoplastic resin were used to form the mouthpiece (molding step).
(3) In the mouthpiece made in (2) above, an open window 22 was made so that the crown of the teeth to be straightened (occlusal surface and maximum abutment of the teeth) except for the cervical portion was exposed (making an open window step). The excess portion of the mouthpiece was also shaved off, leaving the contact portion 23.
(4) A button-shaped fixation source 3 was bonded to the innermost side of the dental arch, one on each side.

In this example, the orthodontic force-applying component 4 is an orthodontic elastics, which is fixed to the mouthpiece body 2 by hanging portion 43 on the fixation source 3 at the innermost side of the mouthpiece body in the dental arch direction. The mouthpiece type orthodontic device 1 in this example is an orthodontic device to move the left and right first molars and second molars further backward bodily movement of teeth by hanging the orthodontic force-applying component on the left and right first molars, respectively, and applying orthodontic force to them.

The mouthpiece type orthodontic device 1 made as described above was worn by the inventor for 20 hours a day for 35 days.

The orthodontic force-applying component 4, the orthodontic elastics, was replaced once a day for both the left and right sides.

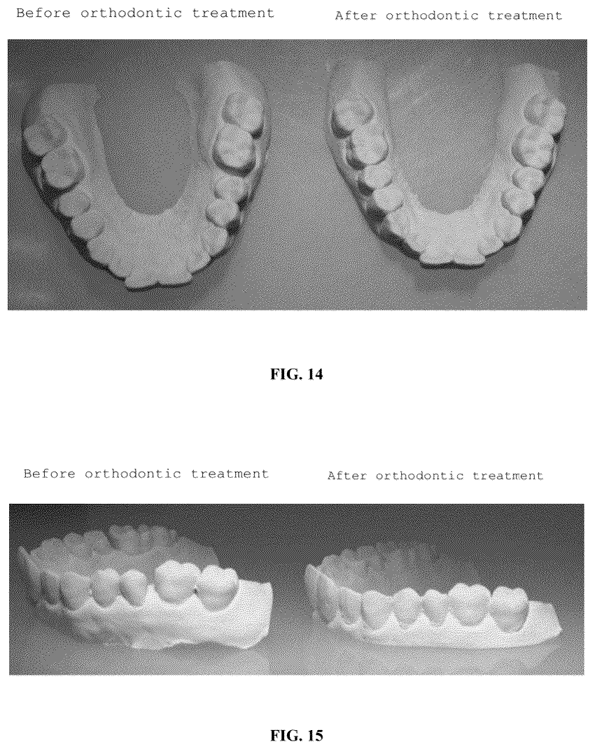

After a period of 35 days, a dental model of the inventor after orthodontic treatment was made by the same method as described in (1) of <Method of making the mouthpiece body 2> above. The dental models made before and after orthodontic treatment are shown in FIGS. 14 and 15.

The left side of FIG. 14 is the tooth model before orthodontic treatment, and the right side of FIG. 14 is the tooth model after orthodontic treatment. The left side of FIG. 15 shows the tooth model before orthodontic treatment, and the right side of FIG. 15 shows the tooth model after orthodontic treatment.

It is clear from FIGS. 14 and 15 that the mouthpiece type orthodontic device 1 can be used for 20 hours per day for 35 days, changing the orthodontic force-applying component 4 once per day, to move two or more molars simultaneously.

### INDUSTRIAL APPLICABILITY

According to the present invention, the burden on the patient during orthodontic treatment can be reduced. It also allows simultaneous bodily movement of teeth of two or more molars, which was difficult in the past.

### REFERENCE SIGNS LIST

1 Mouthpiece type orthodontic device
2 Mouthpiece body
21 Mating portion
22 Open window
23 Contact portion
3 Fixation source
31 Hook portion
4 Orthodontic force-applying component
41 Hanging portion
42 Connecting portion
43 Fixing portion
5 Orthodontic auxiliary component
6 Stopper portion
61 cutout
T1 Teeth to be straightened
T2 Teeth to be straightened
T3 Teeth to be straightened
T4 Teeth to be straightened
H1 Height of mouthpiece type orthodontic device
H2 Height of mouthpiece type orthodontic device
W Thickness of mouthpiece type orthodontic device

1. A mouthpiece type orthodontic device, comprising a mouthpiece body for fitting to dental arch and an orthodontic force-applying component for applying orthodontic force to the teeth to be straightened,
the mouthpiece body has a structure in which at least the teeth to be straightened are exposed without being fitted when the mouthpiece body is fitted to dental arch,
the orthodontic force-applying component has a hanging portion for hanging on the teeth to be straightened and a fixing portion fixed to the mouthpiece body,
and the orthodontic force-applying component applies an orthodontic force to the teeth to be straightened rooted by the tension between the hanging portion and the fixing portion of the orthodontic force-applying component.

2. A mouthpiece type orthodontic device, comprising a mouthpiece body for fitting to dental arch and an orthodontic force-applying component for applying an orthodontic force to the teeth to be straightened,
the mouthpiece body has an open window at least at a portion corresponding to the teeth to be straightened,
the orthodontic force-applying component has a hanging portion for hanging on the teeth to be straightened and a fixing portion fixed to the mouthpiece body,
and the orthodontic force-applying component applies an orthodontic force to the teeth to be straightened by the tension between the hanging portion and the fixing portion of the orthodontic force-applying component as a root.

3. The mouthpiece type orthodontic device according to claim 2, wherein the open window is a closed type with the entire circumference defined by a frame.

4. The mouthpiece type orthodontic device according to claim 2, wherein the open window is an open type, with a portion of the circumference defined by the frame and spatially open at the portion where the frame is missing.

5. The mouthpiece type orthodontic device according to claim 4, wherein the edge of the frame of the open window is raised to form a hook portion, and the orthodontic force-applying component is fixed to the mouthpiece body by hanging the fixing portion on the hook portion.

6. The mouthpiece type orthodontic device according to claim 1, wherein the hanging portion is a member for hanging on the side of the teeth to be straightened in the direction of the dental arch.

7. The mouthpiece type orthodontic device according to claim 3, wherein the fixing portion is located at the innermost side of the mouthpiece body in the direction of the dental arch.

8. The mouthpiece type orthodontic device according to claim 1, wherein the hanging portion is a member for hanging on the incisal or occlusal surface of teeth to be straightened.

9. The mouthpiece type orthodontic device according to claim 1, wherein the mouthpiece body has a mating portion for being fitted to teeth not to be straightened.

10. The mouthpiece type orthodontic device according to claim 9, wherein the mouthpiece body has a stopper portion for temporarily hanging the hanging portion before fitting the mouthpiece body to the dental arch,
the stopper portion is connected to the mating portion for mating the teeth to be straightened and the adjacent teeth not to be straightened,
the stopper portion is equipped with a cutout for temporarily hanging the hanging portion at a position corresponding to the space between the teeth to be straightened and the teeth not to be straightened.

11. The mouthpiece type orthodontic device according to claim 9, wherein the mouthpiece body is equipped with a stopper portion to temporarily hang the hanging portion before fitting the mouthpiece body into the dental arch,
the stopper portion is a protrusion on both sides of the mating portion for mating the teeth to be straightened and the adjacent teeth not to be straightened, in the direction of the dental arch.

12. The mouthpiece type orthodontic device according to claim 9, wherein a slit is provided in the mating portion for hanging and fixing the fixing portion at a position corresponding to the space between adjacent teeth not to be straightened.

13. The mouthpiece type orthodontic device according to claim 1, wherein the connecting portion of the orthodontic force-applying component that connects at least the hanging portion and the fixing portion is made of a material having resilience.

14. The mouthpiece type orthodontic device according to claim 1, wherein a resilience member extending from one or two of the fixing portions and folding back at the hanging portions to assume a circular or semi-circular form.

15. The mouthpiece type orthodontic device according to claim 1, wherein the thickness of the frame portion of the open window in the mouthpiece body is thicker than the thickness of other portions of the mouthpiece body.

16. The mouthpiece type orthodontic device according to claim 1, wherein the mouthpiece body has a contact portion in contact with the hard palate or alveolar ridge.

17. An orthodontic system, comprising a mouthpiece type orthodontic device according to claim 1, and an orthodontic auxiliary component attached to the teeth to be straightened to prevent the orthodontic force-applying component from detaching from the orthodontic teeth to be straightened or from cutting into the neck of the orthodontic teeth.

18. A method of manufacturing a mouthpiece type orthodontic device comprising;
a correction step wherein a corrected dental model is made, in which the shape of the side of the teeth to be straightened in the patient's dental mold model is corrected so that the gap between the teeth to be straightened is sufficient for the movement of the teeth to be straightened,
a molding step wherein a mouthpiece body is made based on a corrected dental model, and
a making an open window step wherein an open window is made in the portion of the mouthpiece body corresponding to the teeth to be straightened.
